(19) United States
(12) Patent Application Publication
(10) Pub. No.: US 2009/0155408 A1
(43) Pub. Date: Jun. 18, 2009

(54) NOVEL NaCl SALT SUBSTITUTE, ITS USE AND PRODUCTS CONTAINING SAME

(75) Inventors: Camille Dupuy-Cornuaille, La Madeleine (FR); Pascal Lejeune, Tourcoing (FR); Jean-Jacques Muchembled, Marcq en Baroeul (FR); Alain Simonneau, Paris (FR)

Correspondence Address: SUGHRUE MION, PLLC, 2100 PENNSYLVANIA AVENUE, N.W., SUITE 800, WASHINGTON, DC, 20037, US

(73) Assignee: Lesaffre Et Compagnie, Paris (FR)

(21) Appl. No.: 12/300,936

(22) PCT Filed: May 15, 2007
(86) PCT No.: PCT/FR2007/051271

§ 371 Date: Nov. 14, 2008

(30) Foreign Application Priority Data
May 15, 2006 (FR) 06/04295

(51) Int. Cl. A23L 1/237

(52) U.S. Cl. 426/2; 426/649

(57) ABSTRACT

The present invention relates to a novel substitute for common salt NaCl, comprising at least one yeast extract, flour of aromatic nature and a low-sodium salt, and to its use as a salting agent. The invention also relates to the use of yeast extract and of flour of aromatic nature for their masking effects on the off-flavours of low-sodium salts, in particular potassium and/or ammonium salts.

The present invention relates to a novel substitute for common salt NaCl and to its use as a salting agent.

There has been for many years a demand for reducing the amount of sodium present in food, especially in bread, which is identified as a major salt vector. This is because excessive consumption of sodium might have very harmful health consequences, and might in particular promote arterial hypertension. A certain number of public health bodies thus recommend reducing this consumption of sodium in food. However, reducing the addition of salt to a food such as baking doughs leads to bland cooked products, that consumers do not find particularly appealing.

A certain number of low-sodium salts have thus been identified for their capacities to give foods a salty taste. These compounds, referred to as low-sodium substitutes, are mainly potassium and/or ammonium salts and may be used in total or partial replacement for common salt NaCl. However, along with the desired salty taste, these compounds also provide “off-flavours”, i.e. undesirable after-tastes or spurious flavours. These “off-flavours” have been widely described in the literature as after-tastes of metallic, bitter and soapy type. These low-sodium substitutes are thus often perceived as unpleasant and disagreeable by the consumer and may even strongly degrade the taste and flavour of foods containing them. This drawback thus limits their uses as substitutes for common salt NaCl, even though the public health bodies strongly recommend their use. Such low-sodium substitutes therefore do not offer per se a fully satisfactory solution for reducing sodium in food.

Many publications have already described this problem and have attempted to solve it. Thus, it has been proposed to combine low-sodium salts, in particular potassium chloride, with lactose or dextrose (U.S. Pat. No. 3,860,732), fumaric acid (U.S. Pat. No. 3,505,082) or a mixture of magnesium chloride and magnesium sulphate (WO 98/53 708).

It has also been proposed to combine low-sodium salts with yeast autolysates. Publications U.S. Pat. No. 4,297,375 and EP 0 103 994 A1 (Standard Oil Company) have thus proposed the use of yeast autolysate to reduce the bitterness of ammonium chloride or potassium chloride. However, such a solution entails drawbacks. Firstly, it requires the use of large amounts of yeast autolysate. Furthermore, it is known that yeast autolysate gives typical aromatic notes, especially of chicken, meat and cheese. Although such aromatic notes are, indeed, capable of masking the perception of the bitterness of low-sodium salts, they nevertheless limit the use of autolysates to certain specific applications such as chicken stocks, or sausages, as is the case in these publications. Moreover, apart from the flavour-enhancing effect of autolysate, no salty effect intrinsic to yeast autolysate is mentioned. A certain number of these drawbacks are moreover mentioned and acknowledged in these publications U.S. Pat. No. 4,297,375 and EP 0 103 994 A1.

There is thus a need for a substitute for common salt that can be used in wide applications, which is capable of providing a strong salty taste without providing the drawbacks mentioned above.

The Applicant recently described in a previous patent application WO 2005/087 013 a salting agent and flavour enhancer comprising a combination of a yeast extract with acidic fermented flour. The Applicant has now discovered, particularly surprisingly and unexpectedly, that such an agent and, more generally, combinations of yeast extract with flours of aromatic nature, moreover have the capacity of masking the off-flavours of standard low-sodium substitutes when used in combination therewith.

The present invention thus relates to a novel substitute for common salt NaCl, comprising at least one yeast extract, fermented flour of aromatic nature and a low-sodium salt, and to its use as a salting agent. The invention also relates to the use of yeast extract and of flour of aromatic nature for their effect of masking the off-flavours of low-sodium salts, in particular potassium and/or ammonium salts.

The present invention thus provides a novel substitute for common salt, comprising at least one yeast extract, flour of aromatic nature and a low-sodium salt. Such an agent is noteworthy in that it affords a masking effect on the off-flavours of low-sodium salt, without the drawbacks mentioned previously, especially typical aromatic notes of chicken, meat and cheese.

Such an effect is very surprising with regard to the knowledge concerning this product, and is almost in contradiction with the prior art. Specifically, this salting agent that is lacking in the perceptible taste and flavour of yeast extracts, nevertheless makes it possible to mask the off-flavours of low-sodium substitutes. Thus, the present invention allows the preparation of an agent that gives a strong salty taste provided not only by the low-sodium salt, but also by the yeast extract and the flour of aromatic nature. In addition, the yeast extract and the flour of aromatic nature mask the off-flavours of low-sodium substitutes, which makes it possible to obtain a common salt substitute that has a pleasant flavour and that does not degrade the taste perception or the flavour of foods containing it. This therefore enables it to be used in a large number of applications, in particular in breadmaking.

The present invention also offers the undeniable advantage of combining standard low-sodium substitutes with a yeast extract and flour of aromatic nature, which are natural products and have a better image in the eyes of consumers.

In addition, by means of the present invention, the low-sodium salt content of foods may also be reduced.

The present invention is particularly advantageous in that it also offers a substitute for table salt, kitchen salt or cooking salt, which may be used in domestic or industrial application, as such or incorporated into food compositions. It thus allows the amount of sodium in the diet to be reduced greatly or even completely eliminated, and without causing the consumer any organoleptic frustration. The present invention thus provides a response that corresponds perfectly to the recommendations put forward by public health bodies and to the choice criteria of consumers.

Moreover, the present invention offers a response that is particularly suitable for facilitating the oral administration of potassium salts in the treatment of hypokaliaemia. By means of the various combinations of salts it proposes, it also makes it possible to control and adapt the supply of potassium, magnesium and ammonium salts as a function of the consumer's needs.

One subject of the present invention is thus a substitute for common salt, comprising at least one yeast extract, flour of aromatic nature, preferably acidic fermented flour, roasted malted flour and/or mixtures thereof and a low-sodium salt. Preferentially, the low-sodium salt is chosen from potassium salts and ammonium salts, and mixtures thereof. In a particularly advantageous manner, the low-sodium salt will be an ammonium chloride, a potassium chloride or a mixture of these two salts.

According to the present invention, the term “substitute for common salt” will be understood as meaning an agent that can be used for its salty effect in total or partial replacement for common salt NaCl and thus reduce the supply of sodium.

Yeast extracts are known products. As indicated previously, they are commonly used as flavour enhancers. According to the invention, the term “yeast extract” means the soluble fraction obtained after enzymatic hydrolysis of yeast cells preferably belonging to the genus Saccharomyces. Also according to the invention, the yeast extract is preferably the soluble fraction obtained after autolysis of the said yeast cells, i.e. after enzymatic hydrolysis performed solely by the endogenous enzymes of yeast. The hydrolysis of yeast cells may also be performed by using exogenous enzymes, i.e. by adding additional enzymes, especially such as proteases.

Preferably, the yeast extract is separated from the insoluble part of the yeast cells. The yeast extract thus separated from the insoluble part offers the advantage of better storage without the appearance of aromatic notes due to oxidation of the membrane lipids of the insoluble part.

According to the invention, the yeast extract preferably belongs to the genus Saccharomyces and more preferably belonging to the species Saccharomyces cerevisiae, including the species known as Saccharomyces carlsbergensis. The said yeast cells Saccharomyces cerevisiae are also often known as Saccharomyces carlsbergensis when it is beer yeast, the exact taxonomic name being Saccharomyces cerevisiae according to “THE YEASTS, a taxonomic study”, 3rd edition, edited by N. J. W. Kreger van Rij—1984 (however, according to the 4th edition of this 1998 publication, Saccharomyces carlsbergensis has two synonyms—Saccharomyces cerevisiae and Saccharomyces pastorianus: it is the 3rd edition of this publication dating from 1984 that is taken as reference in the present document).

Brewing yeast extracts are generally characterized by the presence of a detectable amount of humulones, which amount is preferably as low as possible. The said yeast extract of the agent according to the invention may especially contain and/or be a brewing yeast extract, this brewing yeast extract preferably being debittered, this debittering possibly being performed beforehand via the usual and well-known techniques. Preferentially, the yeast extract is in the form of a dry extract.

The yeast extract containing the agent according to the invention is preferably a yeast extract obtained without addition of salt. Preferably, when the yeast extract comprises or is an extract of brewing yeast, the brewing yeast extract will be judged by a tasting panel as very sparingly bitter. Preferably, the yeast extract contained in the agent according to the invention will be judged by such a tasting panel as having few or no notes of “dairy”, “buttery” or “cheese” type and in general as having a neutral taste profile with no pronounced note.

According to one advantageous embodiment, the yeast extract will be a yeast extract rich in 5′-nucleotides. Processes for obtaining yeast derivatives rich in 5′-nucleotides are described, for example, in documents U.S. Pat. No. 4,810,509, EP-A-0 299 078 and WO 02/067 959 and also in the reference text “Yeast Technology” by G. Reed and T. W. Nagodawithana, 2nd edition (Van Nostrand Reinhold, ISBN 0-442-31892-8) pages 382 to 385. A significant salty effect was very advantageously obtained with baker's yeast extracts containing at least 10% of 5′-nucleotides.

The salt substitute will also comprise flour of aromatic nature. The flour of aromatic nature may be a flour of heat-mediated aromatic nature or a flour of intrinsic aromatic nature.

According to the invention, the expression “flour of heat-mediated aromatic nature” will mean a flour obtained by a process including a heating step. This heating step promotes the Maillard reactions and allows the production of the desired aromatic notes. Overdried flours obtained with a heating step whose duration and/or intensity is not sufficient to develop aromatic notes do not constitute a flour of aromatic nature. According to the invention, the flour of heat-mediated aromatic nature is also characterized by an EBC value of greater than or equal to 8 when it is derived from a flour with an initial EBC value of strictly less than 3. When the flour of heat-mediated aromatic nature is derived from a flour with an initial EBC value of greater than or equal to 3, it is characterized by an increase of this EBC value of 10 or more points. The EBC (European Brewery Convention) value is determined by a known and standardized method known as Analytica EBC No. 4.7.2, conventionally applied in brewing to measure the colour of malts.

In general, the heating step may be of 3 types:
heating of the grain to obtain browning,
heating by malting and roasting of the germed grain,
heating of the flour itself in dry phase or in wet phase. The wet phase may optionally have undergone a prefermentation before drying, especially in the case of acidic fermented flours. The flour may be obtained from all or part of the grain alone (bran flour or germ flour).
   The flour of heat-mediated aromatic nature is often termed in the literature as “grilled”, “toasted” or “roasted”.
   Preferentially, wheat or rye flours of heat-mediated aromatic nature and even more preferentially such acidic fermented or roasted malted flours will be used.

According to the invention, the expression “flour of intrinsic aromatic nature” will be understood to mean a flour naturally containing aromatic notes, without a heating step being necessary. Such flours are especially germ, bran, chestnut, buckwheat, quinoa and teff flours.

Advantageously, roasted malted flours, acidic fermented flours, wheatgerm flours and/or bran flours will be used as flour of aromatic nature.

According to a first preferential embodiment of the invention, the flour of aromatic nature will be a roasted malted flour. Roasted malted flour is a known product, obtained by a process of standard malting and roasting. Examples that may be mentioned include roasted malted barley, malted rye or malted wheat flours and/or mixtures thereof. According to one preferential mode, the flour of aromatic nature will be a roasted malted wheat flour.

According to a second preferential embodiment of the invention, the flour of aromatic nature will be an acidic fermented flour. Acidic fermented flour, also known as dehydrated fermented flour, corresponds to a dry product obtained by drying a dough fermented by means of microorganisms belonging to leavening bacteria, and optionally, in addition, by means of leavening yeasts. Leavening bacteria are especially described in Chapter 4.2, and in particular 4.2.3, of the reference book “Handbuch Sauerteig—Biologie—Biochemie—Technologie” by Spicher and Stephan, 4th edition (ISBN 3-86022-076-4). These bacteria are said to be lactic acid bacteria since they produce lactic acid during the fermentation of the dough and thus contribute towards the flavour-enhancing effect.

According to the invention, the fermented flour is acidic due to the lactic acid it contains. It is thus distinguished especially from the dry ferment described in patent ZA-A-9 400 543 (Unilever), which, since it is obtained by fermentation solely with yeasts, has very different properties.

The acidic fermented flour is generally sold under the French trade names: farine fermentée, farine pré-fermentée, levain sec or levain déshydraté, under the English trade names: dry or dried sourdough, dry or dried leaven or levain, dry or dried fermented flour, dry or dried prefermented flour, sourdough concentrate, sourdough powder, and sour flour, and under the German names Trockensauer and Sauerteigpulver.

According to the invention, the acidic fermented flour as defined above is obtained by drying a fermented dough comprising one or more breadmaking cereal flours, one or more bran-rich milling products or a mixture of one or more breadmaking cereal flours with one or more bran-rich milling products. An example of such a milling product is micronized bran.

Thus, the acidic fermented flour may be obtained from a fermented dough comprising wheat flour (=Triticum aestivum wheat flour) and/or rye flour, one or more bran-rich milling products derived from wheat and/or one or more bran-rich milling products derived from rye, or a combination of wheat flour(s) and/or rye flour(s) with one or more bran-rich milling products derived from wheat and/or rye. The acidic fermented flour present in the agent according to the invention may be derived from a fermented dough comprising one or more cereal flours, comprising one or more bran-rich milling products or comprising a mixture of one or more cereal flours with one or more bran-rich milling products, this dough also possibly containing cereal germs. Preferably, the acidic fermented flour is derived from a fermented dough comprising wheat flour and/or rye flour, one or more bran-rich milling products derived from wheat and/or one or more bran-rich milling products derived from rye, or a mixture of wheat flour and/or rye flour with one or more bran-rich milling products derived from wheat and/or rye. The dough may also contain ground wheatgerm.

The acidic fermented flour preferably has a total microbial flora of less than or equal to 10⁶ CFU (Colony-Forming Units)/g, preferably less than or equal to 10⁵ CFU/g and even more preferably less than or equal to 10⁴ CFU/g.

The dose of lactic acid in the acidic fermented flour is advantageously greater than or equal to 50 g per kg of fermented flour, more advantageously at least 70 g per kg of fermented flour and even more advantageously at least 100 g per kg of fermented flour.

The agent according to the invention advantageously has a weight ratio between the dry matter of flour of aromatic nature and the dry matter of yeast extract of from 0.25 to 15, preferentially from 0.8 to 5 and more preferentially about 2.5. Thus, the preferential ratios range from 0.8 to 2.6, preferably from 1.0 to 2.3, more preferably from 1.2 to 2.0 and even more preferably from 1.2 to 1.8.

According to the invention, the term “low-sodium salt” will be understood as meaning a salting agent other than the yeast extract and/or the flour of aromatic nature, and not containing sodium, preferably a mineral agent. It will preferentially be potassium and ammonium salts. Potassium chloride (KCl), ammonium chloride (NH₄Cl) and mixtures thereof are the preferred salts according to the present invention. By virtue of the high salting power that it affords, ammonium chloride is particularly advantageous. A particularly advantageous mixture according to the invention is a mixture whose NH₄CI/KCl ratio is between 0.05 and 0.66 and preferably about 0.1.

In a particularly advantageous manner, the substitute for common salt will consist exclusively of yeast extract, of flour of aromatic nature, preferentially chosen from acidic fermented flours, and roasted malted flours, and mixtures thereof, and a low-sodium salt, preferentially chosen from potassium and ammonium salts, and mixtures thereof, more preferentially ammonium chloride (NH₄Cl) or potassium chloride (KCl), and mixtures thereof.

The substitute for common salt and the compositions according to the invention may also contain, according to need, a small amount of sodium. Preferably, they will be completely free of added sodium.

The agent according to the invention advantageously has a weight ratio between the dry matter of low-sodium salt and the dry matter of yeast extract and of flour of aromatic nature of from 0.15 to 3, preferentially from 0.4 to 2.3 and more preferably of about 0.7.

The substitute for common salt according to the invention may be in any form that is suitable for its use in food. It is preferably in dry form. According to a first embodiment, it is in the form of a simple mixture of the constituents in dry form. According to a second embodiment, it is in the form of a product of identical or similar presentation to that of kitchen salt NaCl, i.e. homogeneous and of the same particle size as common salt NaCl in the form of fine salt, coarse salt or fleur de sel. The size of the granules will thus advantageously be between 100 and 3000 microns in diameter and preferably between 200 and 2000 microns in diameter. These characteristics may be obtained by using standard techniques and processes known in the field of formulation, especially coating, crystallization or aggregation techniques. The crystal of low-sodium salt may thus be coated with the yeast extract and the flour of aromatic nature. The flour of aromatic nature may also be used as a carrier and may be coated with a mixture of yeast extract and of low-sodium salt. According to one alternative, the constituents of the agent are dissolved and then crystallized simultaneously such that the yeast extract and the flour of aromatic nature are trapped in the low-sodium salt. The dry products constituting the agent may also be aggregated together.

The substitute for common salt may also contain other compounds of interest. These may be compounds required for formulating the agent in the desired form. Such compounds will preferentially have no perceptible taste or flavour liable to degrade the organoleptic qualities of the substitute for common salt and/or in the compositions in which the said agent is liable to be used. For example, they may be additives such as texturing agents such as microcrystalline cellulose, dextrose or magnesium stearate, adjuvants, anti-aggregating agents such as calcium silicate (E552), anticaking agents such as wheat fibres, or technological auxiliaries. They may also be compounds that are of interest in terms of public health such as fluorine and iodine or other salts such as magnesium salts, in particular magnesium chloride (MgCl₂) and magnesium sulphate, especially when the low-sodium salt is a potassium salt. Such a mixture offers the advantage of overcoming dietary deficiencies in magnesium and potassium, in accordance with the recommendations of public health bodies.

One subject of the invention is the use of the agent according to the invention in total or partial replacement for common salt NaCl. The substitute for common salt may be used as a product per se for its salting effect, i.e. in total or partial replacement for household salt NaCl. It may also be added for its salting effect in a composition according to the invention intended for human food or animal feed. According to the invention, the agent may be used to reduce the amount of sodium, or even to eliminate it, in human food and/or animal feed.

A subject of the present invention is thus a process for preparing a composition intended for human food or animal feed, which consists in replacing some or all of the amount of sodium chloride with the substitute for common salt according to the invention. Advantageously, the relative content of sodium will be reduced by at least 25%, and/or the absolute content of sodium will be reduced by at least 0.12 g per 100 g of product. Preferentially, the composition will be prepared without any addition of sodium salts and will have a sodium content that is halved relative to common compositions of the same nature and less than 0.12 g, preferentially less than 0.02 g and more preferentially less than or equal to 0.01 g per 100 g of product.

The present invention thus also relates to any composition intended for human food and/or animal feed containing the said substitute for common salt. It may especially be a bakery product, cooked-meat products, dressing products, ready-cooked meals and any other cooked or uncooked complex food preparation. Advantageously, these ready-to-eat compositions will contain less than 0.12 g of sodium per 100 g or 100 ml of product, preferentially less than 0.04 g, preferably less than 0.02 g and even more preferentially less than 0.005 g of sodium per 100 g or 100 ml of product.

According to another advantageous embodiment, the compositions intended for human food and/or animal feed containing the said substitute for common salt contain 0.14 g or less than 0.14 g of sodium per consumed portion (“per labelled serving” “per referenced amount”) and preferably 0.005 g or less than 0.005 g of sodium per consumed portion.

Preferential compositions according to the invention that may be mentioned include breadmaking improvers and breadmaking products such as bakery dough, bread and other cooked bakery products. Such products are particularly suitable in the context of a low-sodium diet.

Among the bakery products that may be mentioned are bakery doughs comprising unfermented cereal flour, baker's yeast, flour of aromatic nature, preferentially acidic fermented flour or malted roasted flour, and yeast extract, a low-sodium salt and that has a content of sodium or Na⁺ of less than 0.50%. Such a dough may be frozen. Another interesting field of the invention concerns frozen precooked dough balls that may be obtained by fermentation, precooking and freezing of a dough according to the invention.

They may also be cooked bakery products that may be obtained by fermenting and cooking an abovementioned dough, such as breads, preferably French sticks, sweet-dough bread products and/or brioches. Preferably, the cooked breadmaking products according to the invention are common French loaves or at least loaves of French type such as French sticks (baguettes).

Preferably, when the acidic fermented flour is used in the substitute for common salt, the cooked product obtained will have a lactic acid content in the crumb of between 150 and 1000 ppm.

A breadmaking improver according to the invention may be dry or liquid and may also comprise one or more ingredients with an improving effect, and especially one or more ingredients chosen from the group consisting of ascorbic acid, emulsifiers, stabilizing thickeners and enzymes. The improver according to the invention may thus comprise one or more ingredients with an improving effect, such as ascorbic acid, L-cysteine, or deactivated yeast, stabilizing thickeners, for instance pregelatinized flour, modified starches, CMC (carboxymethylcellulose), gums, for instance xanthan gum, algal extracts, for instance alginates or carrageenates, or a combination of these various stabilizing thickeners, emulsifiers, for instance lecithin or fatty acid mono- and diglycerides or diacetyl tartaric esters of fatty acid mono- and diglycerides, etc., or alternatively a combination of one or more emulsifiers such as those mentioned above, enzymes, for instance amylases, and in particular α-amylases, for example including maltogen α-amylases or other stale-proofing α-amylases, hemicellulases, and in particular xylanases, glucose oxidases, amyloglucosidases, lipases, phospholipases, etc., cereal flours or other characteristic ingredients of the composition of special breads.

When the dry improver is in powder form, this support may be, for example, oven-dried flour.

According to one variant of the invention, the improver and the breadmaking products in general may also contain an additional amount of toasted wheatgerm and/or of roasted malted wheat flour for their intrinsic aromatic properties intended to give the characteristic taste of bread. Preferentially, the total content of toasted wheatgerm will not exceed 3% relative to the flour used in the breadmaking product and/or the total content of roasted malted wheat flour will not exceed 0.8% relative to the flour used in the breadmaking product.

For example, a dry improver for common French bread will provide, per 100 parts by mass or 100 kg of unfermented flour according to the baker's percentage, of 1.5% to 2% solids of the dry agent according to the invention consisting of flour of aromatic nature, preferentially acidic fermented flour, malted roasted flour and/or mixtures thereof and of the yeast extract and a low-sodium salt (i.e. 1 kg to 1.8 kg of solids per 100 kg of flour), 0.005% to 0.020% of ascorbic acid (i.e. 0.005 kg to 0.020 kg per 100 kg of flour), preferably from 0.005% to 0.015% of ascorbic acid, 0% to 0.3% of saturated fatty acid monoglycerides (i.e. 0 kg to 0.3 kg per 100 kg of flour), xylanases and/or fungal α-amylases, a diluent solid agent or support in order for the dry improver to be able to be used at a baker's percentage that is easy to measure, for instance a percentage of between 1% and 10% and preferably between 1.5% and 5%, and in particular such a percentage as a round figure, for instance 2%, 5% or 10%.

For example, a dry improver for European bread of non-French type will provide, per 100 parts or 100 kg of unfermented flour according to the baker's percentage, from 1.5% to 2% of solids of the dry agent according to the invention consisting of flour of aromatic nature, preferably acidic fermented flour, malted roasted flour and/or mixtures thereof and of the yeast extract and a low-sodium salt (i.e. 1 kg to 1.5 kg of solids per 100 kg of flour), 0.005% to 0.020% of ascorbic acid (i.e. 0.005 kg to 0.020 kg per 100 kg of flour), preferably from 0.006% to 0.012% of ascorbic acid, 0.05% to 0.20% of diacetyltartaric esters of mono- and diglycerides (emulsifier E472e or f) (i.e. 0.05 kg to 0.20 kg per 100 kg of flour), one or more α-amylases preferably including a stale-proofing α-amylase, xylanases, lipases or phospholipases with a reinforcing effect on the gluten network, 0% to 0.20% of one or more stabilizing thickeners, which ensure the softness of the bread or facilitate a breadmaking process involving freezing or deep freezing, for instance gums or algal extracts, i.e. 0 kg to 0.20 kg per 100 kg of flour, a diluent solid agent or support in order for the dry improver to be able to be used at a baker's percentage that is easy to measure, such a percentage being between 1% and 10% and preferably between 1.5% and 5%, for example 2%, 5% or 10%.

In breadmaking, the invention is not limited to these applications of the substitute for common salt according to the invention, but includes all the processes, all the doughs and all the breadmaking products and uses comprising the novel substitute for common salt for breadmaking according to the invention.

The invention thus also covers any process for preparing cooked products comprising:

the preparation of a dough containing unfermented flour, water, flour of aromatic nature, yeast extract, low-sodium salt preferentially chosen from potassium chloride, sodium chloride and mixtures thereof and a raising agent chosen from baker's yeast, baking powder (chemical raising agent) and a combination thereof,

proving of the dough by means of the raising agent, and

cooking of the proved dough,

the said process optionally comprising rolling of the dough between the preparation and proving steps.

Compositions according to the invention may also be the other foods often considered as the highest sodium vectors, namely cooked meat products, soups, cheeses, ready meals, condiments and sauces.

More generally, a subject of the present invention is thus also the use of yeast extract and of flour of aromatic nature to mask the off-flavours of low-sodium salts, in particular potassium chloride and/or ammonium chloride. The yeast extract and the flour of aromatic nature may thus be added to products containing low-sodium salts. According to the invention, the yeast extract and the flour of aromatic nature may also be used to reduce the amount of low-sodium salts. Thus, the invention relates to a method for masking in a food composition the off-flavours of low-sodium salts, in particular potassium chloride and/or ammonium chloride, comprising the addition of a yeast extract and of a flour of aromatic nature. The invention also relates to a method for reducing the amount of low-sodium salts in a food composition, comprising the preparation of a food composition containing a reduced amount of low-sodium salts and the addition of a yeast extract and of a flour of aromatic nature, this addition making it possible to compensate for the reduction in the amount of low-sodium salts, while at the same time maintaining the same salty taste. In addition, the present invention relates to a product or kit comprising a yeast extract and a flour of aromatic nature, and a composition comprising a low-sodium salt, the yeast extract and the flour of aromatic nature being in an amount that is sufficient to generate the adequate salty taste and/or to mask the off-flavours of the low-sodium salt. The invention also relates to a product or kit comprising a yeast extract and a flour of aromatic nature, and a composition comprising a low-sodium salt, for simultaneous use for masking the off-flavours of low-sodium salt and/or for reducing the amount of low-sodium salt, while at the same time maintaining the same salty taste.

A subject of the present invention is thus also a process for preparing a composition, preferably a food composition, containing a low-sodium salt, which consists in adding a yeast extract and flour of aromatic nature and/or in replacing some of the low-sodium salt with a yeast extract and flour of aromatic nature.

A subject of the present invention is also the substitute for common salt containing at least yeast extract, potassium chloride and flour of aromatic nature, preferentially acidic fermented flour or malted roasted flour, as a medicament, especially for the oral treatment of hypokaliaemia.

The examples below are given to illustrate the invention and should not in any way be considered as limiting the scope of the invention.

### EXAMPLES OF SUBSTITUTES FOR COMMON SALT ACCORDING TO THE INVENTION

### Example 1

The substitutes for common salt according to the invention detailed below were prepared by simple mixing of the following constituents:

The acidic fermented flour present in the dry agent according to the invention is obtained by drying a dough based on micronized rye bran fermented with leavening lactic acid bacteria. The fermented flour more specifically used in these examples is sold by the company Lesaffre International, Division Ingrédients, Marcq-en-Baroeul, France, or Lesaffre France Levures et Ingrédients, (commercial name of Silfala), Strasbourg, France, under the trade name Arôme Levain® S400.

The yeast extract present in the dry agent according to the invention is an autolysate of a brewing yeast belonging to the species Saccharomyces cerevisiae. The yeast extract is a yeast extract manufactured without addition of salt. It is a commercial yeast extract that develops notes of “acid”, “bitter” (very weak), “meaty”, “buttery”, “broth”, “roasted” and “grilled” type, which corresponds to the standard profile of a commercial yeast extract without any particularly pronounced note. The standard yeast extract sold by the company Bio Springer, Maisons-Alfort, France, under the trade name Springer® type 101 was more specifically used in these examples.

Substitute 1:

| | as weight % of the composition |
|---|---|
| Yeast extract | 16 |
| Acidic fermented flour | 24 |
| NH₄Cl | 30 |
| NaCl | 30 |

Substitute 2:

| | as weight % of the composition |
|---|---|
| Yeast extract | 16 |
| Acidic fermented flour | 24 |
| NH₄Cl | 30 |
| KCl | 30 |

Substitute 3:

| | as weight % of the composition |
|---|---|
| Yeast extract | 20 |
| Acidic fermented flour | 30 |
| NH₄Cl | 50 |

A panel of experts tested the low-sodium salts alone or included in the substitutes for common salt, diluted to 5 g per litre in water. For each of these agents, a strong salting effect and also a substantial reduction in the off-flavours were perceived (results attached).

### Evaluation of the Substitutes for Common Salt in Water:

YEX denotes a yeast extract.
YEX+flour denotes the mixture of yeast extract (40%) and of acidic fermented flour (60%).
The following agents were tested diluted in water, at a concentration of 5 g/l, by a panel of 7 experts.
Here is the list of samples tasted and classified as regards their salty taste:

| | YEX + flour | YEX | NaCl | KCl | NH₄Cl |
|---|---|---|---|---|---|
| Negative | | | | | |
| control | | | | | |
| Positive | | | 100% | | |
| control | | | | | |
| (NaCl) | | | | | |
| Product F | 60% | | 20% | | 20% |
| Product A | 40% | | 30% | | 30% |
| Product C | 60% | | | 20% | 20% |
| Product D | 40% | | | 30% | 30% |
| Product B | 50% | | | | 50% |
| Product E | | 50% | | | 50% |

Here are the results of the classification, from left to right: from the least salty to the most salty:

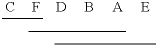

(Note: a line groups together all the samples that do not have any significant difference)
No pronounced differences were obtained between the recipes. E appeared to be the most “salty” product, but B, A and D are also perceived as quite salty.
C and F are the two least salty.
A strong “chicken” note is unanimously cited by the tasters of mixture E.

### Example 2

The substitutes for common salt detailed below correspond to a particularly advantageous embodiment according to the invention and were prepared by simple mixing of the following constituents:

The yeast extract present in the dry agent according to the invention is an autolysate of a baker's yeast belonging to the species Saccharomyces cerevisiae containing at least 10% of 5′-nucleotides. The yeast extract is a yeast extract manufactured without addition of salt. A yeast extract from the range Springer 2000 sold by the company Bio Springer, Maisons-Alfort, France was more specifically used in these examples.

The flour of aromatic nature used in these 2 examples is a roasted malted wheat flour without enzymatic activity and having an EBC value of 100.

Substitute 4:

| | as a weight % of the |
|---|---|
| | composition of the agent |
| Yeast extract | 14.6 |
| Flour of aromatic nature | 36.5 |
| NH₄Cl | 1.8 |
| KCl | 16.4 |
| NaCl | 30.7 |

Such an agent was used as a substitute for table salt alone, but was also incorporated into a food composition with very good taste results. It is particularly suitable for reducing the sodium content in food.

Substitute 5:

| | as a weight % of the |
|---|---|
| | composition of the agent |
| Yeast extract | 15.5 |
| Flour of aromatic nature | 46.4 |
| NH₄Cl | 3.4 |
| KCl | 34.7 |

Such an agent was used as a substitute for table salt alone, but was also incorporated into a food composition with very good taste results. It is particularly suitable for eliminating sodium from food.

1. A substitute for common salt, comprising at least one yeast extract, flour of aromatic nature and a low-sodium salt.

2. The substitute for common salt according to claim 1, in which the low-sodium salt is chosen from potassium salts and ammonium salts, and mixtures thereof.

3. The substitute for common salt according to claim 1, in which the low-sodium salt is chosen from potassium chloride and ammonium chloride, and mixtures thereof.

4. The substitute for common salt according to claim 3, in which the low-sodium salt mixture has an NH₄Cl/KCl ratio of between 0.05 and 0.66.

5. The substitute for common salt according to claim 1, in which the yeast extract is a brewing yeast extract.

6. The substitute for common salt according to claim 1, in which the yeast extract is a baker's yeast extract that contains at least 10% of 5′-nucleotides.

7. The substitute for common salt according to claim 1, in which the flour of aromatic nature is chosen from flours of heat-mediated aromatic nature and flours of intrinsic aromatic nature, and mixtures thereof.

8. The substitute for common salt according to claim 7, in which the flour of heat-mediated aromatic nature is chosen from acidic fermented flours and roasted malted flours, and mixtures thereof.

9. The substitute for common salt according to claim 8, in which the roasted malted flour is chosen from roasted flour of malted wheat, of malted rye or of malted barley, and/or mixtures thereof.

10. The substitute for common salt according to claim 7, in which the flour of intrinsic aromatic nature is chosen from germ, bran, chestnut, buckwheat, quinoa and teff flours, and mixtures thereof.

11. The substitute for common salt according to claim 1, in dry form.

12. Use of a yeast extract and of a flour of aromatic nature to mask the off-flavours of low-sodium salt substitutes, in particular potassium chloride and/or ammonium chloride.

13. Use according to claim 12, in which the flour of aromatic nature is chosen from flours of heat-mediated aromatic nature and flours of intrinsic aromatic nature, and mixtures thereof.

14. Use according to claim 13, in which the flour of heat-mediated aromatic nature is chosen from acidic fermented flours and roasted malted flours, and mixtures thereof.

15. Use according to claim 13, in which the flour of intrinsic aromatic nature is chosen from germ, bran, chestnut, buckwheat, quinoa and teff flours, and mixtures thereof.

16. Use of an agent according to claim 1, as a total or partial substitute for common salt NaCl.

17. A composition intended for animal feed and/or human food, containing the substitute for common salt according to claim 1.

18. A breadmaking improver or breadmaking product containing the agent according to claim 1.

19. The substitute for common salt according to claim 1, as a medicament, the salt being a potassium chloride.

20. Use of an agent according to claim 1, for the preparation of a medicament for the oral treatment of hypokaliaemia, the salt being a potassium chloride.

21. A process for preparing a composition intended for human food and/or animal feed, which consists in replacing some or all of the amount of sodium chloride with the substitute for common salt according to claim 1.

22. A method for masking in a food composition the off-flavours of low-sodium salts, in particular potassium chloride and/or ammonium chloride, comprising the addition of a yeast extract and of a flour of aromatic nature.

23. A method for reducing the amount of low-sodium salts in a food composition, comprising the preparation of a food composition containing a reduced amount of low-sodium salts and the addition of a yeast extract and of a flour of aromatic nature, this addition making it possible to compensate for the reduction in the amount of low-sodium salts, while at the same time maintaining the same salty taste.

24. A product or kit comprising a yeast extract and a flour of aromatic nature, and a composition comprising a low-sodium salt, for simultaneous use for masking the off-flavours of low-sodium salt and/or for reducing the amount of low-sodium salt, while at the same time maintaining the same salty taste.
